(19) United States
(12) Patent Application Publication
(10) Pub. No.: US 2008/0114650 A1
(43) Pub. Date: May 15, 2008

(54) Online coupon distribution method

(75) Inventor: Young Bae Ku, Gangnam-gu (KR)

Correspondence Address: BAINWOOD HUANG & ASSOCIATES LLC, 2 CONNECTOR ROAD, WESTBOROUGH, MA, 01581, US

(73) Assignee: GMARKET INC., Gangnam-gu (KR)

(21) Appl. No.: 11/705,967

(22) Filed: Feb. 13, 2007

(30) Foreign Application Priority Data
Nov. 15, 2006 (KR) 10-2006-0113010

(51) Int. Cl. G06Q 30/00

(52) U.S. Cl. 705/14

(57) ABSTRACT

An online coupon distribution method includes (a) registering coupons in the coupon distribution server, at the seller terminal, (b) selecting, at the purchaser terminal, one of the registered coupons to purchase the coupon, whereby providing the purchase desire information to the coupon distribution server, (c) requesting, at the coupon distribution server, the purchaser of the purchaser terminal to make a payment for the coupon, (d) creating a pair of a code number and an authentication key after checking the payment at the coupon distribution server, the created code number and authentication key being stored in a coupon database (DB), (e) sending, at the coupon distribution server, the code number to the purchaser terminal, and (f) sending, at the coupon distribution server, the authentication key to the purchaser terminal or any authentication key receiving terminal. This improves convenience and profits of a goods seller issuing coupons and a purchaser.

### FIELD OF THE INVENTION

The present invention relates to an online distribution system, and more particularly, to a method for performing online coupon distribution in an online coupon distribution system.

### BACKGROUND OF THE INVENTION

In general commerce, goods stores or service providers (hereinafter, “sellers”) issue and distribute paid and/or free coupons as payment means, discount means or exchange means for goods or services. Coupons are distributed with certain conditions, such as a discount rate, a validity term, and the like. Customers can purchase goods at a discounted price or obtain gifts by using the coupons.

In a typical coupon distribution method, a seller issues coupons and provides them to customers directly or upon goods delivery. The coupons are returned to the sellers by the customers using the coupons at goods stores.

Recently, with the development of the Internet, goods stores or service providers build their website in a virtual space and provide coupons on the website to customers. This eliminates a need for customers to directly visit off line stores or service providers. The online coupons may be printed by an output device such as a printer or downloaded as an image with a unique number to a mobile terminal such as a mobile phone, and then be present to stores.

However, such coupons do not easily spread due to issues of recognition or reliability of coupon issuer. Distributed coupons cannot be tracked and a recovery rate of the coupons cannot be easily predicted. A discount rate of the coupons is conservatively determined for seller's risk management. In the case of merchandise coupons as paid-coupons, benefits are conservatively determined due to a long validity term, e.g., a five-year term. In addition, as sellers provide free coupons to customers, there is no means to induce customers to use the coupons, other than benefits provided by coupons. If the coupons are not used, they may be discarded due to their certain limitations. In other words, coupon issue itself does not result in goods purchase by customers.

Furthermore, customers must directly visit online or offline coupon providers in order to obtain a variety of coupons. When the customers do not have information on coupon providers, however, they cannot obtain such coupons. Coupons from non-reliable providers may not guarantee rights of goods or service purchasers.

### SUMMARY OF THE INVENTION

It is, therefore, an object of the present invention to provide an online coupon distribution method in which, using a coupon distribution system, a seller freely registers paid-coupons on his or her website and a user selects a specific one of the registered coupons in order to purchase the coupon, which is authenticated when used.

According to the present invention, there is provided an online coupon distribution method, which includes:

(a) registering coupons in the coupon distribution server, at the seller terminal;

(b) selecting, at the purchaser terminal, a specific one of the registered coupons and inputting information indicating that the purchaser desires to purchase the coupon, whereby providing the purchase desire information to the coupon distribution server;

(c) requesting, at the coupon distribution server, the purchaser of the purchaser terminal to make a payment for the coupon;

(d) creating a pair of a code number and an authentication key after checking the payment at the coupon distribution server, the created code number and authentication key being stored in a coupon database (DB);

(e) sending, at the coupon distribution server, the code number to the purchaser terminal; and

(f) sending, at the coupon distribution server, the authentication key to the purchaser terminal or any authentication, key receiving terminal.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram of a coupon distribution system according to the present invention;

FIG. 2 is a flowchart illustrating sequential processes of a coupon distribution method according to the is present invention; and

FIG. 3 is a flowchart illustrating a coupon distribution method for use of sold coupons according to an embodiment of the present invention.

### DETAILED DESCRIPTION OF THE PREFERRED EMBODIMENTS

Hereinafter, preferred embodiments of the present invention will be described in detail with reference to the accompanying drawings so that they can be readily implemented by those skilled in the art.

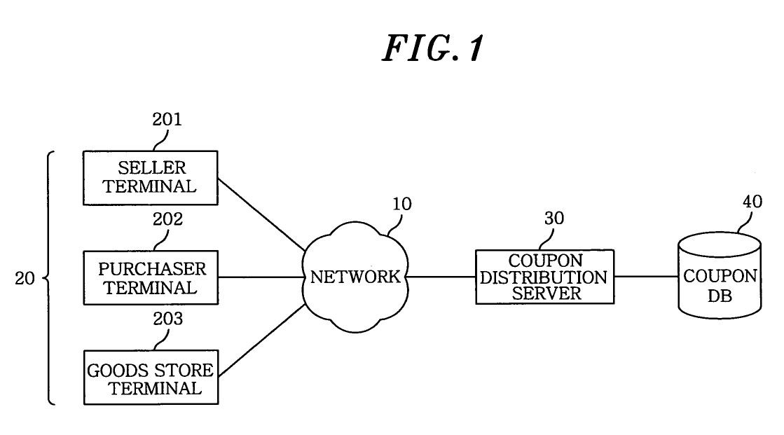

FIG. 1 is a block diagram of a coupon distribution system according to the present invention.

Referring to FIG. 1, the coupon distribution system includes a communication network 10, a terminal 20, and a coupon distribution server 30.

The communication network 10 refers to a data communication network, such as a local area network (LAN), a wide area network (WAN), the Intranet, and the like. For example, the communication network 10 includes a wireless network such as a mobile communication network or a satellite communication network, as well as a wired network such as a private network or a public switched telephone network (PSTN).

The terminal 20 includes a seller terminal 201, a purchaser terminal 202, and a goods-store terminal 203. Examples of these terminals 201, 202 and 203 include computers, mobile phones, and personal digital assistants (PDAs) that can connect to the Internet through wired/wireless communication, and private terminals for connection to the coupon distribution server. The terminals 201, 202 and 203 include a program such as a web browser for connection to a network, through which the terminals may connect to the coupon distribution server.

The coupon distribution server 30 serves to register coupons to be sold via the seller terminal 201. The coupon distribution server 30 receives coupon-related information, e..g., a coupon code, a coupon sales price, a coupon use price at a goods store, a coupon issue form and format, use limitations such as a validity term, coupon benefits and the like from the seller terminal 201 and displays the information on the plurality of terminals 201, 202, and 203 having a connection to the coupon distribution server. The coupon distribution server 30 may register coupon information input by a plurality of sellers according to specific categories. The categories may include a type of benefits dependent on goods with coupons, a seller, a validity term, and the like.

The coupon distribution server 30 may provide, via the seller terminal 201, a menu for enabling a seller to select one of a plurality of registered-coupon sales ways including fixed-price sales, auction, and joint purchase. For reference, the seller may select one sales way through one menu or command before, after, or when registering coupons.

Upon receipt of the information indicating that the purchaser desires to purchase the registered coupons from the purchaser terminal 202, the coupon distribution server 30 requests the purchaser to make a payment for the coupon. After checking that the payment is completed, the coupon distribution server 30 creates a pair of a code number and an authentication key according to a certain rule, stores the created code number and authentication key in the coupon DB 40, and transmits them to the purchaser terminal 202.

Further, upon receipt of a request for coupon use authentication from the terminal 203 of the goods store or the terminal 202 of the coupon purchaser, the coupon distribution server 30 receives the code number and authentication key of the coupon, compares them with the code number and authentication key stored in the coupon DB 40 to determine whether they match, sends the authentication result to the terminal 203 of the goods store, and stores the authentication result in the coupon DB 40.

The coupon DB 40 stores the coupon-related information received from the coupon distribution server 30, e.g., a code number from the seller terminal 201, a goods store where coupons is used, coupon sales price, a coupon use price at a goods store, a coupon issue form and format, use limitations such as a validity term, coupon benefits, and a coupon authentication result.

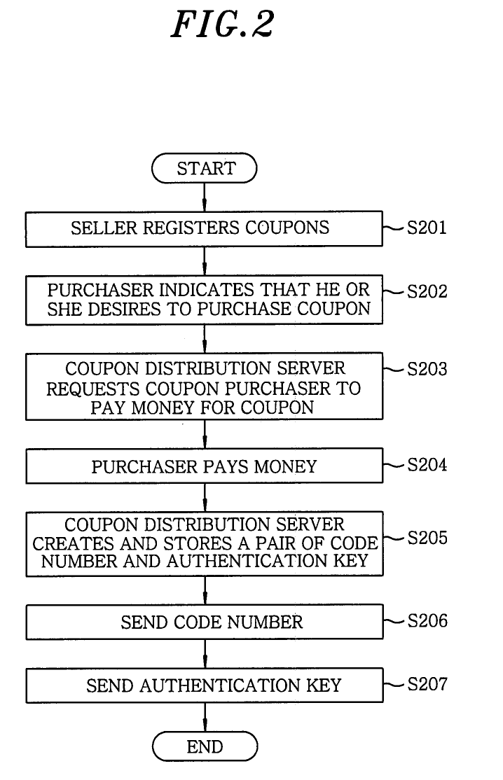

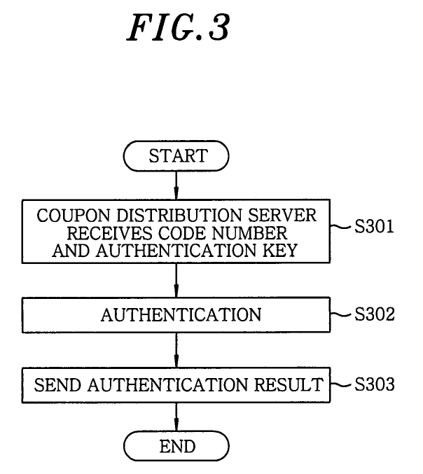

Detailed description for the coupon transaction and authentication in the coupon distribution system will be described with reference to FIGS. 2 and 3.

FIG. 2 illustrates the coupon transaction in a coupon distribution system.

First, the seller of the seller terminal 201 connects to and logs in to the coupon distribution server 30 to register coupons in the coupon distribution server 30 (S201). For the seller to register the coupons, the coupon distribution server 30 provides a menu for enabling the seller to register the coupons using the seller terminal 201.

Specifically, the seller may connect to the coupon distribution server 30 using a connection program such as a web browser installed in his/her terminal 201 and may log in to the coupon distribution server 30 by inputting an ID and a password on an initial log-in window. After logging in, the seller may register the coupons by inputting coupon-related information on a specific screen window provided by the coupon distribution server 30 via the celler terminal 201.

In this case, the seller may register the coupons according to specific categories through a category-specific registration menu provided from the coupon distribution server 30 via the seller terminal 201. Specifically, the seller may call for, on the screen of the terminal, a specific screen window, provided by the coupon distribution server 30, for enabling coupons to be registered according to categories, select a specific one of categories including personnel information such as a seller name, a discount period, gifts, and service type, and then input coupon-related information such as a code number, coupon sales price, a coupon use price at a goods store, a coupon issue form and format, use limitations such as a validity term, and coupon benefits. The registered coupon-related information may be displayed on all terminals having a connection to the coupon distribution server 30. The purchaser having the connection to the coupon distribution server 30 may align or search the registered coupons according to categories in order to easily obtain information on a desired coupon.

The seller of the seller terminal 201 may select one of coupon sales ways including fixed-price sales, auction, joint purchase, and the like in order to register coupons. The seller of the seller terminal 201 may register the coupons while selecting one of the coupon sales ways or select the sales way after registering the coupons depending on the form of a registration and selection screen window provided. That is, the coupon sales way may not be necessarily selected when the coupons are registered or may be changed or modified at any time after the coupons are registered by the seller of the seller terminal 201 having a connection to the coupon distribution server 30.

After connecting to and logging in to the coupon distribution server 30 using the purchaser terminal 202, the purchaser of the purchaser terminal 202 then selects a specific one of the registered coupons to indicate that he or she desires to purchase the coupon (S202). In this case, the purchaser of the purchaser terminal 202 may connect to the coupon distribution server 30 using a connection program such as a web browser installed in his or her terminal and log in to the coupon distribution server 30 by inputting for example an ID and a password on an initial screen window. After logging in, the purchaser of the purchaser terminal 202 may call for a coupon sales screen window provided by the coupon distribution server 30 on its terminal screen and select a desired coupon by retrieving the coupon through keyword input on a menu and aligning coupons according to categories. As the purchaser selects the coupon, information indicating that the purchaser desires to purchase the selected coupon is delivered from the purchaser terminal 202 to the coupon distribution server 30 through the network 10 for wired/wireless communication.

In this case, the coupon distribution server 30 allows the purchaser of the purchaser terminal 202 to select a transfer form for getting the code number and authentication key of the coupon. For example, the purchaser of the purchaser terminal 202 may select to display both the code number and the authentication key of the coupon on the screen of the purchaser terminal or print them through a menu (not shown) provided on the purchaser terminal 202. Alternatively, the coupon distribution server 30 may provide to the purchaser of the purchaser terminal 202 only the code number while allowing the purchaser to receive the authentication key using a separate wireless communication terminal. As another selectable transfer form, both the code number and the authentication key may be sent as a callback short message service (SMS) message to the wireless communication terminal. A coupon using procedure dependent on each transfer form will be described in greater detail later.

According to another embodiment of the present invention, the seller and the goods store, as well as the purchaser, may select a transfer form for getting the code number and the authentication key of the coupon using their terminals 201, 202 and 203. In this case, the coupon distribution server 30 provides a menu for transfer-form selection to the seller terminal 201 or the goods store terminal 203, and receives information on the transfer form selected through the menu.

The coupon distribution server 30 then requests the purchaser of the purchaser terminal 202 to make a payment for the coupon (S203). In this case, the purchaser of the purchaser terminal 202 may make the payment, e.g., using a credit card, online deposit such as automatic transfer, or an accumulated point. The payment may be reserved in the coupon distribution server 30 or a third authority's account and remitted to the seller when the sold coupon is used or the coupon validity term expires according to an escrow system (e.g., paid price deposit means).

The purchaser of the purchaser terminal 202 then makes a payment (S204).

The coupon distribution server 30 then checks the payment, creates a pair of a code number and an authentication key according to a certain rule, and stores the created code number and authentication key in the coupon DB 40 (S205).

The coupon distribution server 30 then sends the code number to the purchaser terminal 202 (S206). The coupon distribution server 30 also sends the authentication key to the purchaser terminal 202 or any authentication key receiving terminal (S207). In other words, the code number and authentication key of the sold coupon may be sent to the same purchaser terminal 202 or to separate terminals. The code number and the authentication key may be sent at the same or different instants. For example, both the code number and the authentication key may be simultaneously sent to the purchaser terminal 202 when the coupon is sold, or the code number may be sent when the coupon is sold and the authentication key may be sent when the coupon is used. Such embodiments will be described in greater detail later.

The coupon distribution server 30 may transmit the code number and the authentication key in the transfer form selected by the purchaser of the purchaser terminal 202. For example, the transfer form may includes a case where the coupon is printed or downloaded and printed on the web browser, or a case where the coupon-related information is sent to an email address or a mobile terminal. The coupon-related information may include coupon sales price, a coupon use price at a goods store, a coupon number, and the like, and may be sent together with various images.

Meanwhile, the coupon distribution server 30 may send the authentication key to the purchaser terminal 202, to which the coupon distribution server 30 has sent the code number of the coupon, or to a separate terminal, e.g., an authentication key receiving terminal. For example, when the coupon distribution server 30 has sent the code number to a personal computer (PC) having a connection to the coupon distribution server 30, it may send the authentication key to a separate wireless communication terminal such as a mobile phone, a PDA, and the like, other than the PC, so that the authentication key is not exposed.

FIG. 3 is a flowchart illustrating a coupon distribution method when the coupon sold as in FIG. 2 is used.

The coupon distribution server 30 may receive the code number and the authentication key of the sold coupon from the goods store terminal 203 in order to authenticate the coupon (S301). In this case, the goods store include any one of an online electronic-commerce site, an offline franchise having a connection to the coupon distribution server 30, and a wireless communication terminal connected to a mobile electronic-commerce site.

In case where the coupon is used at the online electronic-commerce site, the coupon purchaser connects to the electronic-commerce site via his or her terminal 202 and then inputs the code number and the authentication key of the coupon on a specific screen provided from the site. The electronic-commerce site sends the code number and the authentication key to the coupon distribution server 30. Thus, the coupon distribution server 30 can receive the code number and the authentication key from the electronic-commerce site.

In case where the goods store is the offline franchise, the coupon distribution server 30 may receive the code number and the authentication key from a terminal of the offline franchise having a connection to the coupon distribution server 30. In this case, when the terminal of the offline franchise is a wireless communication terminal, the coupon distribution server 30 may receive the code number and the authentication key using an SMS of the wireless communication terminal. For example, the coupon distribution server 30 receives the code number and the authentication key as the wireless communication terminal of the offline franchise connects to the coupon distribution server 30 and sends the code number and the authentication key of the used coupon using its SMS to the coupon distribution server 30.

In case where the authentication key receiving terminal is the wireless communication terminal, the coupon distribution server 30 may receive the authentication key of the sold coupon using a callback SMS of the wireless communication terminal.

In this case, the authentication key receiving step S301 may include receiving the code number of the coupon from the goods store where the coupon is used; fetching an authentication key corresponding to the received code number from the coupon DB 40 and sending the authentication key to the wireless communication terminal; and receiving the authentication key as a callback SMS message from the wireless communication terminal.

Meanwhile, the coupon distribution server 30 may receive the code number and the authentication key from the wireless communication terminal of the purchaser through a callback SMS. Specifically, when the coupon is sold, the code number and the authentication key as a callback SMS message may be sent to and stored in the wireless communication terminal of the purchaser, and the code number and the authentication key stored in the wireless communication terminal may be sent to the coupon distribution server 30 by selecting the callback SMS and then pressing a specific button, e.g., a ‘use’ button on the goods store terminal 203. Preferably, the stored authentication key may be concealed to be not displayed on the wireless communication terminal.

The coupon distribution server 30 compares the received code number and authentication key with the code number and authentication key stored in the coupon DB 40 in order to authenticate the sold coupon (S302). In other words, the coupon distribution server 30 compares the code number and the authentication key stored in the coupon DB 40 when the coupon is sold with the code number and the authentication key received when the coupon is used and determines that the coupon is successfully authenticated when both match.

The coupon distribution server 30 then sends the authentication result to the goods store (S303). The coupon distribution server 30 may send the authentication result to the purchaser or the coupon seller.

In case where the authentication key receiving terminal is the wireless communication terminal of the purchaser and the coupon distribution server 30 receives the authentication key of the sold coupon using the callback SMS of the wireless communication terminal, the coupon distribution server 30 may transmit the authentication result to the wireless communication terminal. Thus, cross-check between the goods store and the coupon purchaser is possible.

According to the present invention, the seller of the seller terminal 201 can set an arbitrary validity term and easily register online coupons that can be aggressively utilized for marketing and stocktaking sale so that coupon information can be more easily delivered to customers and the customers can easily access coupons. This can activate coupon distribution in a market.

As coupons are sold with fee, coupon use by customers can greatly increase, and marketing and stock management costs can be compensated by coupon sales profit even when a coupon recovery rate is low.

The purchasers can obtain coupons of several goods stores and service providers by simply connecting to the coupon distribution server 30 instead of visiting offline franchises or websites. This shortens a distribution time limit and gives a higher discount rate to purchasers.

The payment for coupons is protected by an escrow system (paid price deposit means) and delivered to a seller when coupons are normally used. Thus, it is possible to protect purchasers.

Selection of coupon issue, delivery, and an authentication method can be performed through a medium that the seller or the purchaser selects. This increases convenience of coupon use.

While the invention has been shown and described with respect to the preferred embodiments, it will be understood by those skilled in the art that various changes and modifications may be made without departing from the scope of the invention as defined in the following claims.

What is claimed is:

1. An online coupon distribution method for use in an online coupon distribution system where a seller terminal, a purchaser terminal, a goods store terminal and a coupon distribution server are connected through a network, which comprises:
(a) registering coupons to be sell in the coupon distribution server, at the seller terminal;
(b) selecting, at the purchaser terminal, a specific one of the registered coupons and inputting information indicating that the purchaser desires to purchase the coupon, whereby providing the purchase desire information to the coupon distribution server;
(c) requesting, at the coupon distribution server, the purchaser of the purchaser terminal to make a payment for the coupon;
(d) creating a pair of a code number and an authentication key after checking the payment at the coupon distribution server, the created code number and authentication key being stored in a coupon database (DB);
(e) sending, at the coupon distribution server, the code number to the purchaser terminal; and
(f) sending, at the coupon distribution server, the authentication key to the purchaser terminal or any authentication key receiving terminal.

2. The method of claim 1, wherein the purchaser terminal comprises at least any one selected from a group including a personal computer, a wireless communication terminal, and a private terminal for connection to the coupon distribution server.

3. The method of claim 1, wherein the step (a) includes providing a menu for enabling the seller of the seller terminal to register the coupons according to specific categories.

4. The method of claim 1, further comprising providing a menu for enabling the purchaser of the purchaser terminal to select a transfer form for getting the code number and the authentication key of the selected coupon.

5. The method of claim 1, further comprising reserving the payment in the coupon distribution server or a third authority's account, and remitting a price corresponding to the payment to the seller of the seller terminal when the sold coupon is used or when a validity term of the sold coupon expires.

6. The method of claim 1, further comprising:
(g) when the sold coupon is used, receiving, at the coupon distribution server, the code number and the authentication key of the sold coupon;
(h) comparing, at the coupon distribution server, the received code number and authentication key with the code number and authentication key stored in the coupon DB to authenticate the coupon; and
(i) sending, at the coupon distribution server, the authentication result to the goods store terminal where the coupon is used.

7. The method of claim 6, wherein the step (g) includes receiving the code number and authentication key of the sold coupon from an online electronic-commerce site, the code number and authentication key of the sold coupon being input by the purchaser terminal on a specific screen window provided by the online electronic-commerce site.

8. The method of claim 6, wherein the step (g) includes receiving the code number and authentication key of the sold coupon from a terminal of an offline franchise having a connection to the coupon distribution server.

9. The method of claim 8, wherein the terminal of the offline franchise is a wireless communication terminal, and
wherein the step (g) includes receiving the code number and authentication key of the sold coupon through a short message service (SMS) of the wireless communication terminal.

10. The method of claim 6, wherein the authentication key receiving terminal is a wireless communication terminal of the purchaser, and
wherein the step (g) includes receiving the authentication key of the sold coupon through a callback SMS of the wireless communication terminal.

11. The method of claim 10, wherein the step (g) includes:
receiving the code number of the sold coupon from the goods store of the goods store terminal where the coupon is used;
fetching an authentication key corresponding to the received code number from the coupon DB and sending the fetched authentication key to the wireless communication terminal; and
receiving the authentication key through a callback SMS from the wireless communication terminal.

12. The method of claim 6, wherein the authentication key receiving terminal is a wireless communication terminal of the purchaser, and wherein the step (g) includes receiving the code number and authentication key of the sold coupon through a callback SMS of the wireless communication terminal of the purchaser.

13. The method of claim 12, wherein the authentication key of the sold coupon is stored in the callback SMS in a form that is not displayed on the callback SMS.

14. The method of claim 10, further comprising sending, at the coupon distribution server, the authentication result to the wireless communication terminal.

15. The method of claim 12, further comprising sending, at the coupon distribution server, the authentication result to the wireless communication terminal.

16. The method of claim 6, wherein the goods store includes at least any one selected from a group including an online electronic-commerce site, an offline franchise having a connection to the coupon distribution server, and a mobile electronic-commerce site.
